(19) United States
(12) Patent Application Publication
(10) Pub. No.: US 2019/0172323 A1
(43) Pub. Date: Jun. 6, 2019

(54) CULINARY MAPPING TOOL FOR DETECTING COOKING STATUS IN POT AND CULINARY MAPPING AND EVALUATION METHOD

(71) Applicant: Dongdong DENG, Guangdong (CN)

(72) Inventor: Dongdong DENG, Guangdong (CN)

(21) Appl. No.: 16/321,340

(22) PCT Filed: Jul. 26, 2017
(86) PCT No.: PCT/CN2017/094437

§ 371 Date: Jan. 28, 2019

(30) Foreign Application Priority Data
Jul. 27, 2016 (CN) 201610598175.6
Jul. 27, 2016 (CN) 201620797294.X

(51) Int. Cl. G08B 5/36; G08B 21/20; G08B 5/22; G10L 25/51; G10L 25/18; H05B 1/02

(52) U.S. Cl. CPC G08B 5/36; G08B 21/20; G08B 5/228; H05B 1/0266; G10L 25/51; G10L 25/18; G08B 5/224

(57) ABSTRACT

A culinary mapping tool for detecting cooking status in a pot, comprising a sound sensor (21) capable of directly or indirectly collecting audio signal within a pot body (11) of a cooking pot, and a spectrum analysis terminal for receiving the signal from the sound sensor (21). The spectrum analysis terminal comprises an audio receiver (22), a filter (23), an audio converter (26), and an audio spectrum output device connect in sequence for signal transmissions. Owing to the sound sensor (21) configured to collect audio signal from the pot body (11) of the cooking pot, a user can hear a degree of doneness of food and gain knowledge of cooking status of the food in the pot without opening the pot. The signal collected by the sound sensor (21) is received by the spectrum analysis terminal, and is then subject to noise filtering performed by the filter (23) and conversion to form an audio spectrum segment. The audio spectrum segment can be displayed in various audible or visible formats so as to provide a more direct sound or view for understanding the cooking status within the pot, thereby offering an ergonomic means of assessing and determining a degree of doneness of food. A culinary mapping and evaluation method is also provided which allows visual understanding of cooking status within a pot and can be used to evaluate a degree of doneness of food.

### TECHNICAL FIELD

The present invention relates to an auxiliary technology for evaluating and analyzing cooking status in a pot, and particularly to a culinary mapping tool for detecting cooking status in a pot and a culinary mapping and evaluation method.

### BACKGROUND

Food status is currently made aware through senses of vision, hearing, and smelling. Visual sense is the most direct way, especially for bulk foods. Smelling can sense degree of cooking, but it is compromised by the blocking of wafting odor by the lid. Hearing requires a shorter distance from a cooking food, or a quiet environment. The sound changes to a specific sound at the time when the rice is cooked, and so does the boiling of water.

The degree of cooking can be roughly determined by timing, but it may be undercooked or overcooked (if undercooked, food will be returned to the pot for repeated cooking, which consumes a lot of energy). The degree of cooking can also be determined empirically through real-time status of food, but accurate determination relies on extensive experience and intensive observation. Since modern people are busy with work and life, they don't have much time to study cooking skills, and many people are not able to make dishes that satisfy themselves or even complete an ordinary cooking process. This is mainly attributed to the fact that people have difficulty in handling the cooking process and determining the final food status, especially due to the unavailability of direct observation of the degree of cooking, thus making cooking a difficult task. In addition, improper cooking (mostly overcooking) may reduce nutrients in food and indirectly increase energy consumption. Modern housewives juggle careers and family and have no time to study recipes, or they even take care of other things while cooking, thus, the quality and taste of the dishes are even more difficult to guarantee.

A conventional method for determining the degree of cooking is achieved by using an infrared sensor and based on a combination of temperature and time. However, infrared detection usually only obtains the surface temperature of food and water in the pot also affects accurate detection. Temperature measurement in the pot and on the lid is not accurate because the adiabaticity of air blocks temperature propagation. Infrared temperature measurement is compromised by water vapor in the heating pot. A probe-type temperature sensor requires frequent opening of the lid, which is very inconvenient and may also results in “half-cooked”.

### SUMMARY OF THE INVENTION

The technical problem to be solved by the present invention is to provide a culinary mapping tool for detecting cooking status in a pot, which avoids frequent opening of the pot and provides reference data for speculating and evaluating degree of cooking; and a culinary mapping and evaluation method for monitoring cooking status in a pot without opening the pot, in order to evaluate and determine degree of cooking in the pot.

The present invention provides a culinary mapping tool for detecting cooking status in a pot, comprising a sound sensor capable of directly or indirectly collecting an audio frequency within the pot, and a spectrum analysis terminal for receiving a feedback signal from the sound sensor. The spectrum analysis terminal comprises an audio receiver, a filter, an audio converter, and an audio spectrum output device, connected in sequence for signal transmission.

As an improvement, the audio converter is followed by a comparison processor comprising a comparison unit and an output control unit.

As an improvement, the sound sensor conducts through a solid material or is directly in contact with the body or the lid of the cooking pot.

As an improvement, the sound sensor is a microphone or a microelectromechanical sensor.

As an improvement, the sound sensor is a laser monitor comprising a laser transmitter, and a photoelectric detector for receiving a laser transmission signal and converting it into an electrical signal.

As an improvement, the spectrum analysis terminal is a computer, a smartphone a smartwatch or a dedicated terminal device that is preloaded with an analysis software.

As an improvement, the spectrum analysis terminal further comprises a warning indicator connected with the audio converter, and the warning indicator comprises at least one of a sound warning unit, a visual flashing warning unit, and a vibration warning unit.

As an improvement, the spectrum analysis terminal further comprises a circuit breaker connected with the audio converter for controllable cutting off the heat source in the cooking pot; and a storage unit connected with the audio converter.

As an improvement, the audio spectrum output device is a display that presents sound spectrum or a lamp that reflects status of a sound spectrum by color and/or brightness.

Another aspect of the invention relates to a culinary mapping and evaluation method comprising steps of:

S1. installing a sound sensor by direct contacting or conductively contacting the sound sensor in a body or a lid of a cooking pot, or installing a laser monitor against a body of a cooking pot as a non-contact type of sound sensor, and the sound sensor transmitting collected audio signal to a spectrum analysis terminal; and

S2. filtering environmental noises through a filter, and converting audio signals over a continuous time period into audio spectrum segments which are visually displayed or restored to sound and played by a loudspeaker, whereby food status and degree of cooking in the pot is determined according to a relationship between an audio spectrum segment and food status.

As an improvement, the spectrum analysis terminal is equipped with a timer, a time signal output of which is taken as a culinary evaluation parameter.

As an improvement, the spectrum analysis terminal is inbuilt with a culinary experience database, or linked to an Internet experience sharing database. In step S2, an empirical value and a feedback audio signal are presented in a same visible format and compared, and a warning is generated in audible or visible format at the moment when the value and the signal coincide.

As an improvement, an alarm signal is emitted when the feedback audio signal reaches a dry pot threshold or an audio generated by spilled liquid in contact with a high temperature object is detected.

As an improvement, an intervention signal is emitted simultaneously to trigger cutting off the heating source or an anti-scorching intervention action of the cooking pot.

As an improvement, the audio spectrum segment corresponding to a specific process of cooking of a designated food is recorded and stored as a standard spectrum segment, and the standard spectrum segment so stored or otherwise introduced externally is extracted, based on which a control signal is output to regulate the flux of heating source to allow real-time audio spectrum to coincide with the standard spectrum segment.

The advantages of the invention are described in the following. Food enriched with water or mixed with an amount of water produces different sound characteristics over the whole period of cooking in a pot, which form unique sound frequencies. For example, water bubbling by heating, boiling, dry-out, and food scorching generates significantly different sound characteristics. Furthermore, the softening of food also brings slight change in the sound characteristics. The pot body that is in direct contact with food and moisture thereof directly inherits the sound characteristics (the sound frequency) and the sound transmits in a solid object with low loss. Owing to the sound sensor configured to collect an audio signal from the pot, a user can hear a cooking sound in the pot and aware of cooking status in the pot without opening the lid. An audio signal sent by the sound sensor is received by the spectrum analysis terminal, and then subject to noise filtering by the filter. The audio signals over a continuous time period are converted into audio spectrum segments by the spectrum analysis, so as to digitally and quantitatively analyze a certain process of cooking food. Then, the audio spectrum segments are visually displayed by a display such that the degree of cooking can be visualized. Alternatively, the audio spectrum segments are further combined with program control to generate instruction for subsequent actions. Here, the change of the audio is displayed in a curve or other forms to more directly understand the status change in the cooking pot. According to visual data reflected by different status, the cooking status in a pot can be understood at any time, so that the degree of cooking can be evaluated and determined.

The culinary mapping and evaluation method uses a sound sensor to detect and collect the audio signal in a pot through a contact manner or a non-contact laser detection manner. The signal is then converted and transmitted to the spectrum analysis terminal, followed by conversion and restoration to be presented in a visible or audible format. The mapping result is provided to for evaluating the food status in a pot without opening the pot, leading to blind determination of cooking status and degree of cooking.

### BRIEF DESCRIPTION OF THE DRAWINGS

FIG. 1 is a flow schematic presentation of blindly determining the degree of cooking according to the present invention.

FIG. 2 is a structural schematic presentation of a pot assembly kit including a culinary mapping tool for detecting cooking status in the pot according to an example of the present invention.

FIG. 3 is a structural schematic presentation of a pot assembly kit including a culinary mapping tool for detecting cooking status in the pot according to another example of the present invention.

FIG. 4 is a structural schematic presentation of a pot assembly kit including a culinary mapping tool for detecting cooking status in the pot according to another example of the present invention, and further comprising a dedicated terminal device of regular specification.

FIG. 5 is a schematic presentation of a smartwatch and an audio spectrum display manner thereof.

FIG. 6 is a partially enlarged structural schematic presentation of a culinary mapping tool with a mini dedicated terminal device for detecting cooking status in a pot.

### DETAILED DESCRIPTION OF THE INVENTION

The embodiments of the invention will be further described in combination with the drawings.

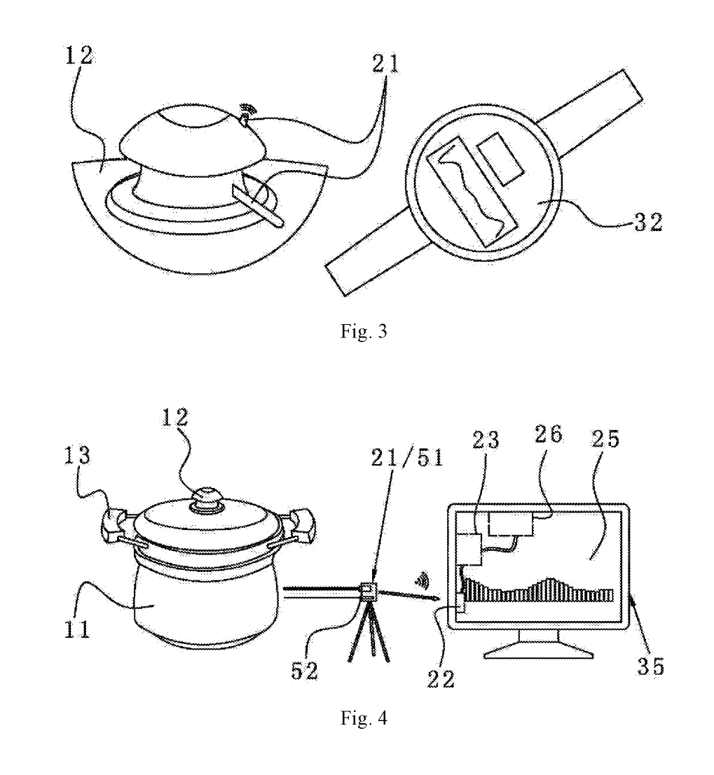

As shown in FIGS. 1 to 4, a culinary mapping tool for detecting cooking status in a pot is provided comprising a sound sensor 21 capable of directly or indirectly collecting (contact or non-contact type) an audio frequency within the pot body 11, and a spectrum analysis terminal for receiving the signal from the sound sensor 21. The frequency spectrum analysis terminal comprises an audio receiver 22, a filter 23, an audio converter 26, and an audio spectrum output device, connected in sequence for signal transmissions. The audio spectrum output device can be a display 25. Owing to the sound sensor 21 configured to collect an audio signal from the pot, a user can hear a cooking sound in the pot and aware of cooking status in the pot without opening the lid 12. An audio signal sent by the sound sensor 21 is received by the spectrum analysis terminal, and then subject to noise filtering by the filter 23. The audio signals over a continuous time period are converted into audio spectrum segments by the spectrum analysis, so as to digitally and quantitatively analyze a certain process of cooking food. Then, the audio spectrum segments are visually displayed by a display 25 such that the degree of cooking can be visualized. Alternatively, the audio spectrum segments are further combined with program control to generate instruction for subsequent actions. Here, the change of the audio is displayed in a curve or other forms to more directly understand the status change in the cooking pot. According to visual data reflected by different status, the cooking status in a pot can be understood at any time, so that the degree of cooking can be evaluated and determined. The example described above is based on the audio frequency mapping tool to detect the cooking status in the pot.

Fast Fourier transform can be selected for recognizing sound and converting it into audio spectrum by the audio converter, and at least one parameter of frequency, amplitude, and spectrum characteristics of the sound can be selected for analysis. The audio frequency over a specific continuous period of time, which represents food status, is converted into audio spectrum and presented visually. Thus, voiceprint that reflects changes in sound characteristics caused by the status changes of moisture of food can be displayed. Voiceprint is a specific audio frequency spectrum, representing a status of a sound wave band, and a characteristic segment produced by the corresponding object and extracted from the audio frequency spectrum.

The audio spectrum output device can be a display in any forms for presenting audio spectrum, a compiler that outputs a signal segment for subsequent action, or a lamp that reflects the status of the audio spectrum by color and/or brightness. For example, the cooking status in a pot can be presented by the lamp by conversion from a cool color to a warm color, or in combination with the brightness of the lamp for more accurate indication.

By detecting and analyzing the change in audio frequency caused by the changes of food structure and moisture in the process of cooking food, graphic representations are displayed or sounds are played to indicate the status in a pot, such that the degree of cooking can be evaluated and food would not be undercooked, overcooked or scorched. In one embodiment, the frequency and amplitude of the sound are analyzed, for example by Fast Fourier transform (FFT), and graphically displayed for determining the degree of cooking. In addition, the dominant and harmonic waves of the audio signals collected over specific intervals are analyzed, so that the exact cooking status can be accurately evaluated by taking into consideration the weight of foods, amount of sauce, amount of water, and types of cooking device used.

The degree of cooking can be determined directly based on the changes in amplitude and frequency of the audio signal generated and collected, or indirectly based on the comparison with known empirical data. They can be performed alone or in combination.

The filter is used to filter environmental noises (such as noises generated by gas burning, ventilator, or occasionally human, etc.) and the noise generated by the movement of a cooking tool.

The contact-type sound sensor 21 can be placed on the side wall, bottom, or top (including the lid) of a cooking device, or even a holder of a cooking device (such as the holders of an induction cooker or a gas stove), or an external mechanical device (such as a body part of a robot), as long as the sound sensor 21 can be in contact with the pot body 11, either directly or indirectly by fixed conduction, such as metal conduction. In one embodiment, the tool described herein includes a wireless microphone, a wireless sensor, and a tablet that can communicate wirelessly with the microphone and the sensor. The audio signals of the microphone and the temperature signals of the wireless sensor are transmitted to the smart device (i.e., the tablet) for calculating and analyzing the frequency spectrum changes. The results can also be combined with the information regarding predicted weight of food, the amount of sauce added, the amount of water, types of cooking device and other factors to determine the degree of cooking, or to use in next process.

Preferably, the audio recognition converter 26 is followed by a comparison processor comprising a comparison unit and an output control unit. The signal collected was compared with pre-recorded or externally introduced standard cooking data to determine whether the cooking status needs to be adjusted. If yes, an intervention signal is output to remind the operator to perform a corresponding cooking action, or a control signal is output to directly perform the next application, such as automatically adjusting or cutting off the heat delivery flux, or controlling the cooking device to automatically open the lid.

Preferably, the sound sensor 21 is directly in contact with the pot body 11 or the lid of a cooking pot, and utilizes metal solids for sound conduction. The sound sensor 21 is kept at a certain distance from the heat source, which is beneficial for the performance and service life of the sensor. Alternatively, the sound sensor 21 can also be attached directly to the lid 12. For example, the sound sensor 21 is designed as a handle of the lid, or disposed at the position of pot handle 13 to indirectly collect audio signals from the pot body 11. Most preferably, the sound sensor 21 is directly attached to the pot body 11 to reduce noises generated during the sound transmission process.

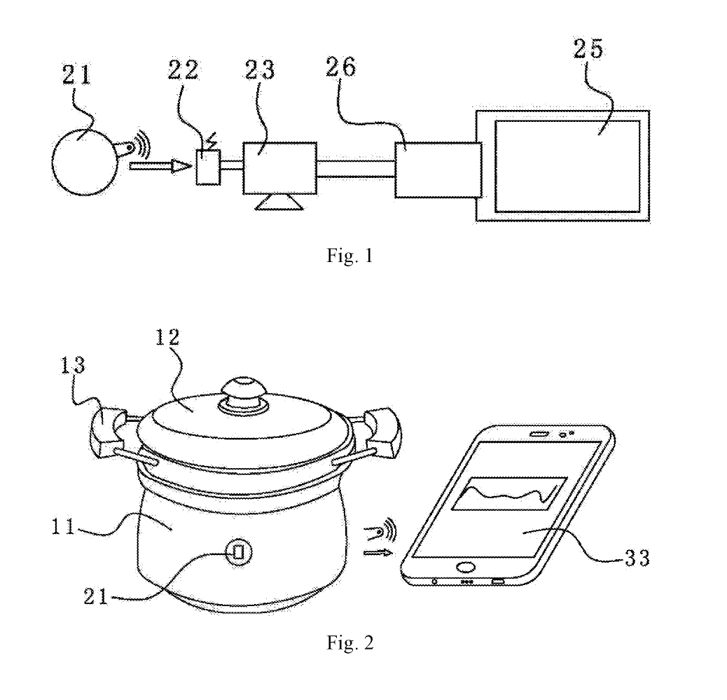

Preferably, the sound sensor 21 is a microphone or a microelectromechanical sensor and/or a laser monitor 51. The laser monitor 51 comprises a laser transmitter, and a photoelectric detector for receiving a laser transmission signal and converting it into an electrical signal. The microphone can be directly attached to the pot body 11 or the lid to monitor sound status changes in the pot, as shown in FIG. 2. The microphone can also contact the pot body indirectly and collect signal by solid conduction to detect the sound status (an audio spectrum in a specific period of time) in the pot.

At present, a new type of monitoring or eavesdropping tool has emerged. The tool utilizes a laser emitting at the glass of the room being monitored, and receives the laser feedback from the glass. The vibration waves generated by the sound waves in the room are collected by the laser monitor 51 when they vibrate on the glass, and optical signals are converted into electrical signals, and then filtered and amplified, and finally the sound is restored through a speaker, and the monitor process can be completed without placing a detectaphone in the position being monitored.

By using the laser monitor technology, the laser monitor 51 can provide a non-contact type of monitoring. The laser monitor 51 is installed at a position other than the pot body. It emits a laser of a certain wavelength (such as a laser having a wavelength of 780 nm) as a light source at the pot body. Since the metal or porcelain from which the pot body is made has a rigidity similar to glass, the vibration wave will be transmitted, and the sound vibration wave in the pot will be mapped. The laser monitor 51 is kept a certain distance from the pot body, so that the vibration wave of the pot body 11 can be read and the sound status in the pot can be “monitored”. The laser monitor 51 avoids being in direct contact or heat-conduction contact with the pot body 11, thereby reducing the thermal influence of the pot body on the sound sensor.

The laser monitor 51 can also be equipped with an infrared thermometer 52 to simultaneously measure the surface temperature of the pot body and provide more data to more accurately analyze the cooking status in a pot.

The non-contact type of laser monitor 51 is separated from the measured objects such as the pot body 11 and the lid 12, thus, a single laser monitor 51 can be used for multiple pots without the need to install the monitors one by one, which is cost-saving.

The combination of contact type monitoring and non-contact type monitoring of the sound status in a pot can improve its anti-interference ability and more accurately measure the audio spectrum in the pot and reflect the changes of the audio spectrum (sound status).

However, the invention described herein is not limited to existing audio collection and conduction device. Any auxiliary device capable of audio collection and conduction can be used to achieve the purpose of the invention.

Preferably, as shown in FIGS. 2-5, the spectrum analysis terminal is a computer, a smartwatch 32, a smartphone 33, or a dedicated terminal device 35 that is pre-loaded with an analysis software. The corresponding software is downloaded to a smart terminal and combined with the sound sensor 21 to form a combination kit for signal transmission such that the food status in a pot can be heard and the internal status of food can be seen through a visual diagram. As shown in FIG. 6, it is also possible to use a dedicated terminal device 35, which is miniaturized and attached with a screen 36, and directly installed on the pot body 11, the pot handle 13 or the lid 12 to form a combined mini dedicated terminal device, which can avoid data delay or interruption of wireless transmission. As shown in FIG. 4, the dedicated terminal device 35 can also have a certain specification, and it is installed in the kitchen to provide a large visual diagram display for convenient use by people with poor vision. In the era of big data, by sharing data, people can learn better cooking skills and cooking data (including proportions, ingredients, and the audio spectrum reference curve of the cooking process) from others to perform the cooking process control. It is also possible to directly determine whether to take an intervention action by the cook according to the curve or color change observed. Through the cloud data, people can remotely control the cooking process outside the kitchen, mainly adjusting the firepower, switch and monitoring the cooking process, in order to avoid accidents. There is no need to lower head near the pot and uncover for observation, so as to avoid hot steam burning the face.

The audio collection and conduction device and the spectrum analysis terminal can be combined with the pot to form a set of cooking tools, or can be used as a cooking auxiliary tool to combine with existing cooking pot. The audio collection and conduction device can be installed on the pot body 11 or the lid 12, or any position at which the audio signal can be conducted and collected.

Preferably, the spectrum analysis terminal further comprises a warning indicator connected with the audio converter, which comprises at least one of a sound warning unit, a visual flashing warning unit, and a vibration warning unit, so that the user can be promptly reminded to perform an intervention action to avoid accidents.

Preferably, the spectrum analysis terminal further comprises a circuit breaker connected with the audio converter 26, which can control a cooking pot to cut off a heat source, and prevent accidents when the user leaves the scene or does not process in time.

Preferably, the spectrum analysis terminal further comprises a storage unit connected with the audio converter 26, which can store spectrum data of preferred cooking process as reference data. For example, it can store the cooking process data of professional chefs, or externally imported standard data, as reference.

Preferably, the audio spectrum output device is a display 25 that presents a sound spectrum or a lamp that reflects a status of sound spectrum by color and/or brightness. The audio spectrum output device can be a display 25 in any form, or a compiler that outputs a signal segment for subsequent process to take a corresponding response action, or lamp that reflects a status of the audio spectrum by color and/or brightness. For example, the process of cooking and the degree of cooking can be expressed by the conversion from a cool color to a warm color of the lamp, or in combination with the brightness of the lamp.

A culinary mapping and evaluation method is provided in order to accurately and blindly determine the degree of cooking, comprising:

S1. installing a sound sensor 21 by direct contacting or conductively contacting the sound sensor 21 in a body 11 or a lid 12 of a cooking pot, or installing a laser monitor against a body 11 of a cooking pot as a non-contact type of sound sensor 21, and the sound sensor transmitting collected audio signal to a spectrum analysis terminal. Owing to the sound sensor 21 configured to collect an audio frequency from the pot body, a user can directly hear cooking status in the pot, which is then presented in a visible or audible format, so as to gain knowledge of the cooking status in the pot without opening the lid 12; and

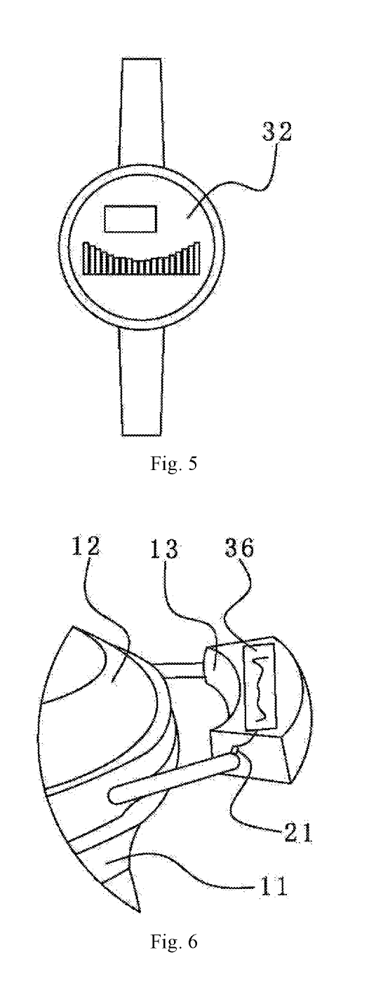

S2. filtering environmental noises through a filter 23, and converting audio signals over a continuous time period into audio spectrum segments which are visually displayed or restored to sound and played by a loudspeaker, whereby food status and degree of cooking in the pot is determined according to a relationship between an audio spectrum segment and food status. The audio signal collected by the sound sensor 21 is received by the audio receiver of the spectrum analysis terminal, and is then subject to noise filtering performed by the filter and displayed so as to view the status of the moisture content and the reaction of food being heated in the pot and evaluate and determine the degree of cooking. Here, the audio change is displayed in a curve, or various forms of audio spectrum, as shown in FIGS. 4 and 5, to more visually understand the status change of cooking food in a cooking pot. Fast Fourier transform can be selected for recognizing sound and converting it into audio spectrum by the audio converter, and at least one parameter of frequency, amplitude, and spectrum characteristics of the sound can be selected for analysis. The audio frequency over a specific continuous period of time, which represents food status, is converted into audio spectrum and presented visually. Thus, voiceprint that reflects changes in sound characteristics caused by the status changes of moisture of food can be displayed. Voiceprint is a specific audio frequency spectrum, representing a status of a sound wave band, and a characteristic segment produced by the corresponding object and extracted from the audio frequency spectrum.

The culinary mapping and evaluation method uses a sound sensor to detect and collect the audio signals in a pot in a contact manner or non-contact laser detection manner. The signal is then converted and transmitted to the spectrum analysis terminal, followed by conversion and restoration to be presented in a visible or audible format. The mapping result is provided to for evaluating the food status in a pot without opening the pot, leading to blind determination of cooking status and degree of cooking.

The above method determines the degree of cooking by detecting and analyzing the audio change caused by the change of the composition and moisture of the cooked food in a pot during the process of cooking, so that the food will not be undercooked, overcooked or scorched. In one embodiment, the frequency, amplitude, and spectrum characteristics of sound are analyzed to determine the cooking status of food in a pot.

Preferably, the spectrum analysis terminal is equipped with a timer, time signal output of which is taken as a culinary evaluation parameter. As one of the evaluation parameters of the cooking process and one of the evaluation reference factors, the time signal is combined with the sound spectrum to more accurately determine the cooking process and more accurately evaluate the status of doneness of cooking food. Compared to many pots with simple timing cooking function, the time factor is not a single, but one of many, parameters of evaluation. It can correct the evaluation of cooking process deviation caused by inherent and external factors, which is a breakthrough for ordinary timing cooking tools and a meaningful improvement.

Preferably, the spectrum analysis terminal is inbuilt with a culinary experience database, or linked to an Internet experience sharing database. In step S2, an empirical value and a feedback audio signal are presented in a same visible format and compared, and a warning is generated in audible or visible format at the moment when the value and the signal coincide. The operator should be reminded that the status of food has changed and that further actions are needed. Alternately, control signals are sent and a further intervention action is carried out by controlling robots to achieve cooking automation.

Preferably, an alarm signal is emitted when the feedback audio signal reaches a dry pot threshold or an audio generated by spilled liquid in contact with a high temperature object is detected, to remind the operator that an intervention action must be taken to avoid danger. The alarm signal can be accompanied by an audible alarm or/and a flashing alarm, to improve the reliability and alertness of the alarm. Dry pot is not the most dangerous accident. A more serious accident is water spilling which, when the cook is not near the pot, is easy to cause gas leak because the spilling may lead to extinguishing of the gas burning without obvious alarm. However, the boiling and spilling of water can be monitored because obvious changes in the sound status (the audio spectrum) in a pot can be detected, particularly the obvious changes in sound when the spilled water contacts the high temperature stove and the pot holder. By using them as an alarm reference spectrum, the system can alert when soup or water spills to avoid more serious accidents.

Preferably, an intervention signal is sent simultaneously to trigger a stove to cut off the heating source or trigger the anti-scorching intervention action of the cooking pot, and measures are taken to prevent the food from scorching or losing edible value. For example, water is injected to prevent and control any risks, which serves as a step of cooking automation.

Preferably, audio spectrum segments of designated foods are recorded and stored as standard spectrum segments. The standard spectrum segment stored or imported from extraneous sources (e.g., a reference spectrum segment shared by other people) is extracted. A control signal is output to regulate the flux of heating source based on the comparison between the real-time audio spectrum and a standard spectrum segment. Thus, the audio spectrum segment data of operation processes of other people (chefs) or the self-cooking processes with better cooking performance can be used as references for cooking, or exogenous standardized audio spectrum segments can be imported as cooking reference spectrum segments for guiding cooking. In the “intervention” position where the corresponding action is required, the corresponding intervention actions (such as adding seasonings, condiments or ingredients) are performed, so that the process of cooking is simplified, and everyone can become a cooking master. It is also possible to output the standardized audio spectrum segments as control signals to automatically regulate the heat flux, so as to fully automate the cooking process, or fully automate the cooking with the help of modern robots.

The following is an example of the processes of boiling and braising.

Hardware: a sound sensing module, a temperature sensing module, a pot, a smart terminal (a computer, a tablet, a smartphone 33, a smartwatch 32 or other smart devices).

Throughout the process, the temperature sensor is only used for auxiliary detection, such as the temperature changes caused by opening the lid and adding ingredients and water and the temperature at which cooking is nearly completed when the heat spread has been stabilized, and the key is to prevent dry-out.

The specific process is as follows:

1. Start to put ingredients, cooking aids (such as salt, oil, and sauce), water, and etc. The sound sensor module has no effective output (except for environmental noises), and the temperature sensor outputs normal temperature. Trigger the switch and start cooking.

2. When heating to a certain extent, the sound sensor 21 has a sound output caused by the heating of food and liquids. Due to the uneven heating, few sounds can be detected. However, compared to the environmental noises, the amplitude of some bands increases in the spectrum, although with low frequency. Continuous heating is required without intervention.

3. When food is heated to a certain extent, the sound output caused by the heating of food and liquids is greater. The amplitudes of some bands continue to increase and occur at a larger frequency. Compared to the cooking data downloaded or stored and recorded earlier, important audio spectrum change points appear, which requires the operators to determine by themselves or the smart terminal to perform interventions (such as stirring, adding water, adding ingredients, etc.), so as to make the heat transfer more even and the taste more pleasant.

4. When the amplitude of some bands no longer increases but occur at a stable frequency, it indicates that the surface temperature of food in the pot body 11 tends to stabilize, and the food is continuously heated for a certain period of time at this stage. The curve of existing cooking data stored internally can also be exported for comparison. The smart terminal indicates the completeness of the cooking process, which requires manual intervention to stop heating.

5. When the cooking process is completed but no manual intervention is introduced and the food continues to be heated, the moisture in a pot will gradually evaporate. When it dries out, the pot will make “chi-chi” noise. The noise will be collected by the sound sensor 21 and subject to spectral analysis. This noise will have a single frequency at the highest level. At this point, the smart terminal alerts and outputs: “The pot is drying out”.

The above disclosure is only the preferred embodiments of the present invention, and the scope of the present invention is not limited thereto. Therefore, equivalent changes made by the scope of the present invention remain within the scope of the present invention.

1. A culinary mapping tool for detecting cooking status in a pot, comprising
a sound sensor capable of directly or indirectly collecting an audio signal within the pot, and
a spectrum analysis terminal for receiving the audio signal from the sound sensor,
wherein the spectrum analysis terminal comprises an audio receiver, a filter, an audio converter, and an audio spectrum output device, connected in sequence for signal transmission.

2. The culinary mapping tool of claim 1, wherein the audio converter is connected to a comparison processor comprising a comparison unit and an output control unit.

3. The culinary mapping tool of claim 1, wherein the sound sensor collects the audio signal conducted through solid material or is directly in contact with a body or lid of the pot.

4. The culinary mapping tool of claim 1, wherein the sound sensor is a microphone or a microelectromechanical sensor.

5. The culinary mapping tool of claim 1, wherein the sound sensor is a laser monitor comprising a laser transmitter, and a photoelectric detector for receiving a laser transmission signal and converting it into an electrical signal.

6. The culinary mapping tool of claim 1, wherein the spectrum analysis terminal is a computer, a smartphone, a smartwatch or a dedicated terminal device that is preloaded with an analysis software.

7. The culinary mapping tool of claim 1, wherein the spectrum analysis terminal further comprises a warning indicator connected to the audio converter, and the warning indicator comprises at least one of a sound warning unit, a visual flashing warning unit, and a vibration warning unit.

8. The culinary mapping tool of claim 1, wherein the spectrum analysis terminal is connected with the audio converter and further comprises a circuit breaker for controlling the pot to cut off heat source, and wherein the spectrum analysis terminal further comprises a storage unit connected with the audio converter.

9. The culinary mapping tool of claim 1, wherein the audio spectrum output device is a display that presents sound spectrum or a lamp that reflects status of sound spectrum by color and/or brightness.

10. A culinary mapping and evaluation method, comprising:
S1. installing a sound sensor by direct contacting or conductively contacting the sound sensor in a body or a lid of a cooking pot, or installing a laser monitor against a body of a cooking pot as a non-contact type of sound sensor, and the sound sensor transmitting collected audio signal to a spectrum analysis terminal; and
S2. filtering environmental noises through a filter, and converting audio signals over a continuous time period into audio spectrum segments which are visually displayed or restored to sound and played by a loudspeaker, whereby food status and degree of cooking in the pot is determined according to a relationship between an audio spectrum segment and food status.

11. The culinary mapping and evaluation method of claim 10, wherein the spectrum analysis terminal is equipped with a timer, and time signal output of the timer is taken as a culinary evaluation parameter.

12. The culinary mapping and evaluation method of claim 10, wherein the spectrum analysis terminal is inbuilt with a culinary experience database, or linked to an Internet experience sharing database, and wherein in step S2, an empirical value and a feedback audio signal are presented in a same visible format and compared, and a warning is generated in audible or visible format at the moment when the value and the signal coincide.

13. The culinary mapping and evaluation method of claim 10, wherein an alarm signal is emitted when the feedback audio signal reaches a dry pot threshold or an audio generated by spilled liquid in contact with a high temperature object is detected.

14. The culinary mapping and evaluation method of claim 13, wherein an intervention signal is emitted simultaneously to trigger cutting off the heating source or an anti-scorching intervention action of the cooking pot.

15. The culinary mapping and evaluation method of claim 10, wherein the audio spectrum segment corresponding to a specific process of cooking of a designated food is recorded and stored as a standard spectrum segment, and the standard spectrum segment so stored or otherwise introduced externally is extracted, based on which a control signal is output to regulate the flux of heating source to allow real-time audio spectrum to coincide with the standard spectrum segment.
